(19) United States
(12) Patent Application Publication
(10) Pub. No.: US 2024/0046162 A1
(43) Pub. Date: Feb. 8, 2024

(54) Explainable Artificial Intelligence Toolset for Extracting Logic Inherent in Machine Learning Models

(71) Applicant: Board of Regents, The University of Texas System, Austin, TX (US)

(72) Inventors: Gopal Gupta, Plano, TX (US); Huaduo Wang, Richardson, TX (US); Farhad Shakerin, Redmond, WA (US)

(21) Appl. No.: 18/364,714

(22) Filed: Aug. 3, 2023

Related U.S. Application Data
(60) Provisional application No. 63/370,515, filed on Aug. 5, 2022.

(51) Int. Cl. G06N 20/20

(52) U.S. Cl. CPC G06N 20/20

(57) ABSTRACT

Automated inductive machine learning is provided. The method comprises a) receiving a dataset comprising positive examples and negative examples of a given target literal; b) learning a rule regarding the target literal from the positive examples and negative examples in the dataset according to a gini impurity heuristic; c) responsive to a determination that there are a number of the positive examples in the dataset above a specified tail value are covered by the rule: ruling out those positive examples covered by the rule from the dataset; adding the rule to a rule set; and returning to step b) to learn a new rule for the target literal according to all remaining positive examples and negative examples in the dataset; and d) responsive to a determination that there are no remaining positive examples in the dataset covered by the rule, returning the rule set to a user.

### CROSS-REFERENCE TO RELATED APPLICATION

This application claims the benefit of U.S. Provisional Patent Application Ser. No. 63/370,515, filed Aug. 5, 2022, and entitled “Explainable Artificial Intelligence Toolset for Extracting Logic Inherent in Machine Learning Models,” which is incorporated herein by reference in its entirety.

### BACKGROUND INFORMATION

### 1. Field

The present disclosure relates generally to machine learning, and more specifically to a method of providing explainable rules underlying machine learning models.

### 2. Background

Dramatic success of machine learning has led to a torrent of Artificial Intelligence (AI) applications. However, the effectiveness of these systems is limited by the machines' current inability to explain their decisions and actions to human users because the statistical machine learning methods produce models that are complex algebraic solutions to optimization problems such as risk minimization or geometric margin maximization.

Lack of intuitive descriptions makes it hard for users to understand and verify the underlying rules that govern the model. Additionally, these methods cannot produce a justification for a prediction they arrive at for a new data sample.

### SUMMARY

An illustrative embodiment provides a computer-implemented method for automated inductive machine learning. The method comprises a) receiving a dataset, wherein the dataset comprises positive examples and negative examples of a given target literal; b) learning a rule regarding the target literal from the positive examples and negative examples in the dataset according to a gini impurity heuristic; c) responsive to a determination that there are a number of the positive examples in the dataset above a specified tail value are covered by the rule: ruling out those positive examples covered by the rule from the dataset; adding the rule to a rule set; and returning to step b) to learn a new rule for the target literal according to all remaining positive examples and negative examples in the dataset; and d) responsive to a determination that there are no remaining positive examples in the dataset covered by the rule, returning the rule set to a user.

Another illustrative embodiment provides a system for automated inductive machine learning. The system comprises a storage device configured to store program instructions and one or more processors operably connected to the storage device and configured to execute the program instructions to cause the system to: a) receive a dataset, wherein the dataset comprises positive examples and negative examples of a given target literal; b) learn a rule regarding the target literal from the positive examples and negative examples in the dataset according to a gini impurity heuristic; c) responsive to a determination that there are a number of the positive examples in the dataset above a specified tail value are covered by the rule: rule out those positive examples covered by the rule from the dataset; add the rule to a rule set; and return to step b) to learn a new rule for the target literal according to all remaining positive examples and negative examples in the dataset; and d) responsive to a determination that there are no remaining positive examples in the dataset covered by the rule, return the rule set to a user.

Another illustrative embodiment provides a computer program product for automated inductive machine learning. The computer program product comprises a computer-readable storage medium having program instructions embodied thereon to perform the steps of: a) receiving a dataset, wherein the dataset comprises positive examples and negative examples of a given target literal; b) learning a rule regarding the target literal from the positive examples and negative examples in the dataset according to a gini impurity heuristic; c) responsive to a determination that there are a number of the positive examples in the dataset above a specified tail value are covered by the rule: ruling out those positive examples covered by the rule from the dataset; adding the rule to a rule set; and returning to step b) to learn a new rule for the target literal according to all remaining positive examples and negative examples in the dataset; and d) responsive to a determination that there are no remaining positive examples in the dataset covered by the rule, returning the rule set to a user.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of an inductive system in accordance with an illustrative embodiment;

FIG. 3 depicts a block diagram illustrating the interrelationship between a deep learning flow and an inductive explainability flow in accordance with an illustrative embodiment;

FIG. 4 depicts a diagram illustrating an overview of the FOLD-R algorithm;

FIG. 5 depicts a diagram illustrating an overview of the FOLD-R++ algorithm in accordance with an illustrative embodiment;

FIG. 6 depicts a diagram illustrating an algorithm for calculating information gain;

FIG. 7 depicts a diagram illustrating an algorithm for finding a best literal function in accordance with an illustrative embodiment;

FIG. 8 depicts a flowchart illustrating a process for automated inductive machine learning in accordance with an illustrative embodiment;

FIG. 9 depicts a flowchart illustrating a process for learning a rule regarding a target literal; and

FIG. 10 is a block diagram of a data processing system in which illustrative embodiments may be implemented.

### DETAILED DESCRIPTION

The illustrative embodiments recognize and take into account one or more different considerations as described herein. For example, the illustrative embodiments recognize and take into account that dramatic success of machine learning has led to a torrent of Artificial Intelligence (AI) applications. However, the effectiveness of these systems is limited by the machines' current inability to explain their decisions and actions to human users because the statistical machine learning methods produce models that are complex algebraic solutions to optimization problems such as risk minimization or geometric margin maximization.

The illustrative embodiments also recognize and take into account that lack of intuitive descriptions makes it hard for users to understand and verify the underlying rules that govern the model. Additionally, these methods cannot produce a justification for a prediction they arrive at for a new data sample.

The illustrative embodiments recognize and take into account that machine learning models are opaque, making it hard to gain insight into how the models arrive at their output. Data may be wrong or have biases built into the model. Data may not represent all possibilities. Furthermore, if machine learning models are applied to regulated industries, the decision making process of the model may not comply with transparency requirements such as, e.g., General Data Protection Regulation (GDPR). Therefore, if a machine learning model renders a decision related to, e.g., a loan application or healthcare and cannot provide an explanation of how the decision was reached, the service employing such a model would not be in compliance with the law.

The illustrative embodiments recognize and take into account that the Explainable AI program aims to create a suite of machine learning techniques that: a) Produce more explainable models, while maintaining a high level of prediction accuracy; and b) Enable human users to understand, appropriately trust, and effectively manage the emerging generation of artificially intelligent systems.

The illustrative embodiments recognize and take into account that inductive Logic Programming (ILP) is one Machine Learning technique where the learned model is in the form of logic programming rules that are comprehensible to humans. It allows the background knowledge to be incrementally extended without requiring the entire model to be re-learned. Meanwhile, the comprehensibility of symbolic rules makes it easier for users to understand and verify induced models and even refine them.

The illustrative embodiments provide an inductive learning system that learns default rules and exception rules for mixed (numerical and categorical) data. The inductive learning system is competitive in performance to machine learning algorithms such as XGBoost and multi-layer perceptrons (MLP) but is also able to produce an explainable model that can be understood by humans.

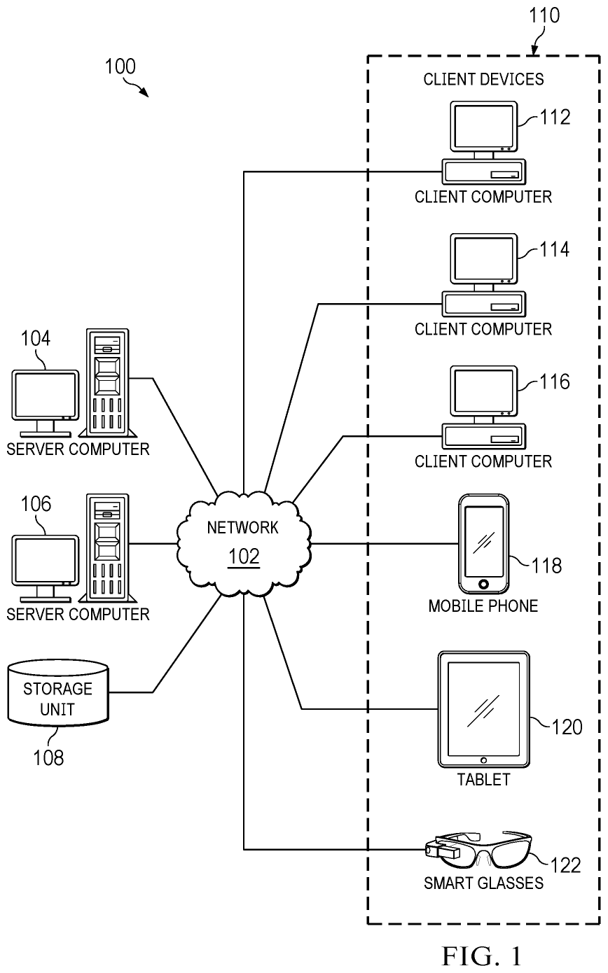

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet computer 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

Supervised machine learning comprises providing the machine with training data and the correct output value of the data. During supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

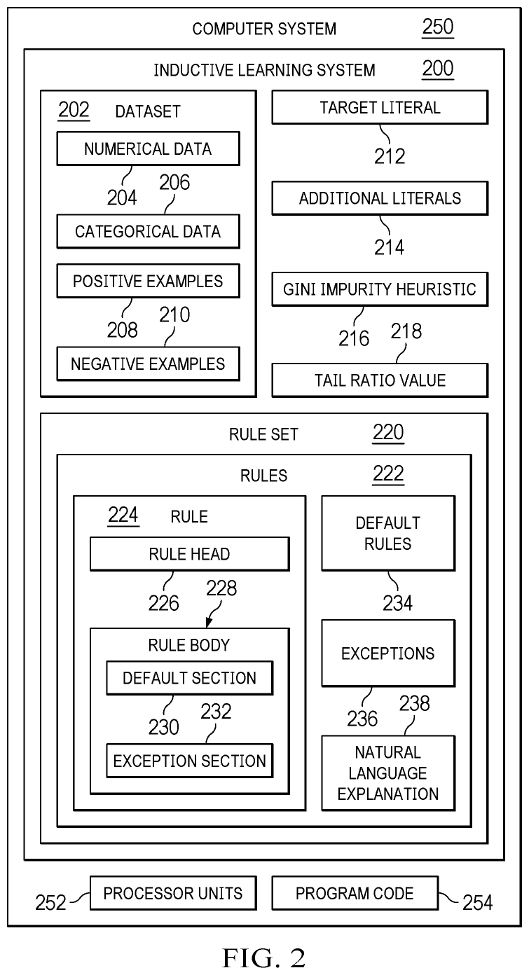

FIG. 2 is a block diagram of an inductive learning system in accordance with an illustrative embodiment. Inductive learning system 200 might be implemented in network data processing system 100 in FIG. 1. Inductive learning system 200 generates a rule set 220 regarding a target literal 212 corresponding to features of a dataset 202.

Dataset 202 may comprise both numerical data 204 and categorical data 206. The dataset 202 may be divided into positive examples 208 and negative examples 210 of the target literal (predicate) 212.

Inductive learning system 200 constructs a number of rules 222 for rule set 220. To construct a rule, inductive learning system 200 starts with the target literal 212 and uses a heuristic to add additional literals (predicates) 214. In the present example, the heuristic comprises gini impurity heuristic 216. The additional literals 214 and resultant rules 222 are evaluated according to the number of positive examples 208 and negative examples 210 they cover. Rules that cover a number of examples below a specified tail ratio value 218 are discarded, resulting in a more compact rule set.

Each rule 224 in the rule set 220 comprises a rule head 226 and rule body 228. The rule head 226 comprises the target literal 212. The rule body 228 comprises a default section 230 and an exception section 232 that are constructed as additional literals 214 are added to the rule 224 according to how they cover positive examples 208 and negative examples 210 in the dataset 202. Rules 222 may be classified as defaults rules 234 or exceptions 236.

In contrast to other machines learning approaches such as artificial neural networks that produce answers without any explanation as to how the answers are derived, the rules 222 in rule set 220 comprise natural language explanations 238 that can be understood by humans. As a result of the explainability of rules 222, users are able to refine the learned model and comply with applicable laws and regulations. The explainability also facilitates the exposure of deficiencies in the data. These rules 222 can be executed on the s(CASP) (solver for Constraints Answer Set Programs) ASP (answer set programming) system.

Inductive learning system 200 can be implemented in software, hardware, firmware, or a combination thereof. When software is used, the operations performed by inductive learning system 200 can be implemented in program code configured to run on hardware, such as a processor unit. When firmware is used, the operations performed by context visualization system 200 can be implemented in program code and data and stored in persistent memory to run on a processor unit. When hardware is employed, the hardware can include circuits that operate to perform the operations in inductive learning system 200.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 250 is a physical hardware system and includes one or more data processing systems. When more than one data processing system is present in computer system 250, those data processing systems are in communication with each other using a communications medium. The communications medium can be a network. The data processing systems can be selected from at least one of a computer, a server computer, a tablet computer, or some other suitable data processing system.

As depicted, computer system 250 includes a number of processor units 252 that are capable of executing program code 254 implementing processes in the illustrative examples. As used herein a processor unit in the number of processor units 252 is a hardware device and is comprised of hardware circuits such as those on an integrated circuit that respond and process instructions and program code that operate a computer. When a number of processor units 252 execute program code 254 for a process, the number of processor units 252 is one or more processor units that can be on the same computer or on different computers. In other words, the process can be distributed between processor units on the same or different computers in a computer system. Further, the number of processor units 252 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

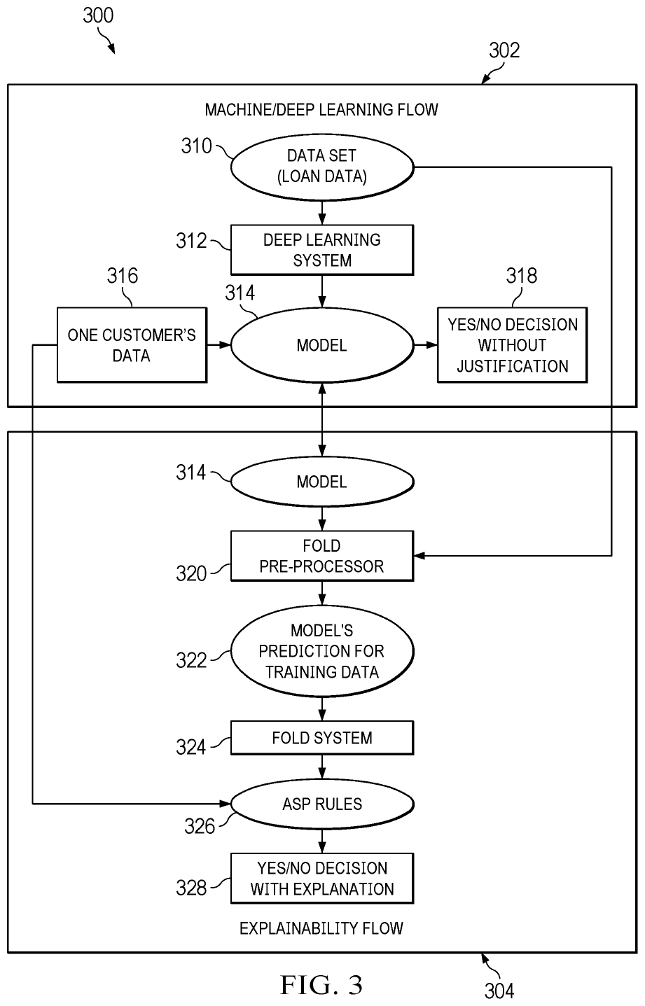

FIG. 3 depicts a block diagram illustrating the interrelationship between a deep learning flow and an inductive explainability flow in accordance with an illustrative embodiment. Flow 300 comprises a typical machine/deep learning flow 302 and explainability flow 304.

Deep learning flow 302 uses a dataset 310 such as, e.g., loan data into a deep learning system 312. The deep learning system 312 typically comprises a number of layers of nodes. These layers include an input layer that receives input data (i.e., dataset 310), one or more hidden layers, and a final output layer. The hidden layers of deep learning systems make them proverbial “black boxes” whose internal operations are not observable.

The deep learning system 312 produces a trained model 314. The model 314 then receives data for a new case such as, e.g., one customer's data 316 and produces a decision 318. Continuing the above loan example, decision 318 may be a yes/no decision regarding a loan. Regardless of the type of decision made, the model 314 does not provide an explanation of how it arrived at that decision.

Explainability flow 304 reverse engineers model 314 to arrive at a set of explainable rules 326 that produce approximately the same predictive results. Explainability flow 304 feed the trained model 314 and the original dataset 310 into a First Order Learner of Default (FOLD) preprocessor 320. The FOLD preprocessor 320 produces the model's prediction 322 for the training data. This prediction 322 is then fed into FOLD system 324 (explained below).

The FOLD system 324 generates a set of answer set programming (ASP) rules 326 that are able to take the customer's data 316 and generate a decision 328 that is the same as decision 318 but with an explanation of how that decision was derived.

The ILP learning problem can be regarded as a search problem for a set of clauses that deduce the training examples. The search is performed either top down or bottom-up. A bottom-up approach builds most-specific clauses from the training examples and searches the hypothesis space by using generalization. This approach is not applicable to large-scale datasets, nor it can incorporate negation-as-failure into the hypotheses. In contrast, the top-down approach starts with the most general clause and then specializes it. A top-down algorithm guided by heuristics is better suited for large-scale and/or noisy datasets.

The First Order Inductive Learner (FOIL) algorithm by Quinlan is a popular top-down inductive logic programming algorithm that generates logic programs. FOIL uses weighted information gain (IG) as the heuristics to guide the search for best literals. The FOLD algorithm by Shakerin is a new top-down algorithm inspired by the FOIL algorithm. It generalizes the FOIL algorithm by learning default rules with exceptions. It does so by first learning the default predicate that covers positive examples while avoiding negative examples, then next it swaps the positive and negative examples and calls itself recursively to learn the exception to the default. Both FOIL and FOLD cannot deal with numeric features directly; an encoding process is needed in the preparation phase of the training data that discretizes the continuous numbers into intervals. However, this process not only adds a huge computational overhead to the algorithm but also leads to loss of information in the training data.

To deal with the above problems, Shakerin developed an extension of the FOLD algorithm, called FOLD-R, to handle mixed (i.e., both numerical and categorical) features which avoids the discretization process for numerical data. However, FOLD-R still suffers from efficiency and scalability issues when compared to other popular machine learning systems for classification. In this paper we report on a novel implementation method we have developed to improve the design of the FOLD-R system. In particular, we use the prefix sum technique to optimize the process of calculation of information gain, the most time consuming component of the FOLD family of algorithms. Our optimization, in fact, reduces the time complexity of the algorithm. If N is the number of unique values from a specific feature and M is the number of training examples, then the complexity of computing information gain for all the possible literals of a feature is reduced from O(M*N) for FOLD-R to O(M) in FOLD-R++.

In addition to using prefix sum, we also improved the FOLD-R algorithm by allowing negated literals in the default portion of the learned rules (explained below). Finally, a hyper-parameter, called exception ratio, which controls the training process that learns exception rules, is also introduced. This hyper-parameter helps improve efficiency and classification performance. These three changes make FOLD-R++ significantly better than FOLD-R and competitive with well-known algorithms such as XGBoost and RIPPER.

Our experimental results indicate that the FOLD-R++ algorithm is comparable to popular machine learning algorithms such as XGBoost and RIPPER wrt various metrics (accuracy, recall, precision, and F1-score) as well as in efficiency and scalability. However, in addition, FOLD-R++ produces an explainable and interpretable model in the form of a normal logic program. A normal logic program is a logic program extended with negation-as-failure. Note that RIPPER also generates a set of CNF formulas to explain the model, however, as we will see later, FOLD-R++ outperforms RIPPER on large datasets.

The illustrative embodiments make the following novel contribution: it presents the FOLD-R++ algorithm that significantly improves the efficiency and scalability of the FOLD-R ILP algorithm without adding overhead during pre-processing or losing information in the training data. As mentioned, the new approach is competitive with popular classification models such as the XGBoost classifier and the RIPPER system. The FOLD-R++ algorithm outputs a normal logic program (NLP) that serves as an explainable/interpretable model. This generated normal logic program is compatible with s(CASP), a goal-directed ASP solver, that can e_ciently justify the prediction generated by the ASP model.

Inductive Logic Programming (ILP) is a subfield of machine learning that learns models in the form of logic programming rules that are comprehensible to humans. This problem is formally defined as:

Given

1. A background theory B, in the form of an extended logic program, i.e., clauses of the form h←l₁, . . . , lₘ, not lₘ₊₁, . . . , not lₙ, where l₁, . . . , lₙ are positive literals and not denotes negation-as-failure (NAF). We require that B has no loops through negation, i.e., it is stratified.

2. Two disjoint sets of ground target predicates E⁺,E⁻ known as positive and negative examples, respectively.

3. A hypothesis language of function free predicates L, and a refinement operator ρ under θ-subsumption that would disallow loops over negation.

Find a set of clauses H such that:
∀ₑ∈E⁺,B∪H [symbol] e
∀ₑ∈E⁻,B∪H [symbol] e
BΛH is consistent.

Default Logic is a non-monotonic logic to formalize commonsense reasoning. A default D is an expression of the form:

$$\frac{A : MB}{Γ}$$

which states that the conclusion Γ can be inferred if pre-requisite A holds and B is justified. MB stands for “it is consistent to believe B”. Normal logic programs can encode a default quite elegantly. A default of the form:

$$\frac{{α}_{1} ∧ {α}_{2} ∧ … ∧ {α}_{n} : M ¬ {B}_{1} , M ¬ {B}_{2} , … M ¬ {B}_{m}}{γ}$$

can be formalized as the following normal logic program rule:
γ: −α₁, α₂, . . . , αₙ not B₁, not B₂, . . . , not Bₘ

where α's and β's are positive predicates and not represents negation-as-failure. We call such rules default rules. Thus, the default

$$\frac{bird ( X ) : M ¬ penguin ( X )}{fly ( X )}$$

will be represented as the following default rule in normal logic programming:
fly(X):—bird(X), not penguin(X).

We call bird(X), the condition that allows us to jump to the default conclusion that X can y, the default part of the rule, and not penguin(X) the exception part of the rule.

Default rules closely represent the human thought process (commonsense reasoning). FOLD-R and FOLD-R++ learn default rules represented as normal logic programs. An advantage of learning default rules is that we can distinguish between exceptions and noise. Note that the programs currently generated by the FOLD-R++ system are stratified normal logic programs.

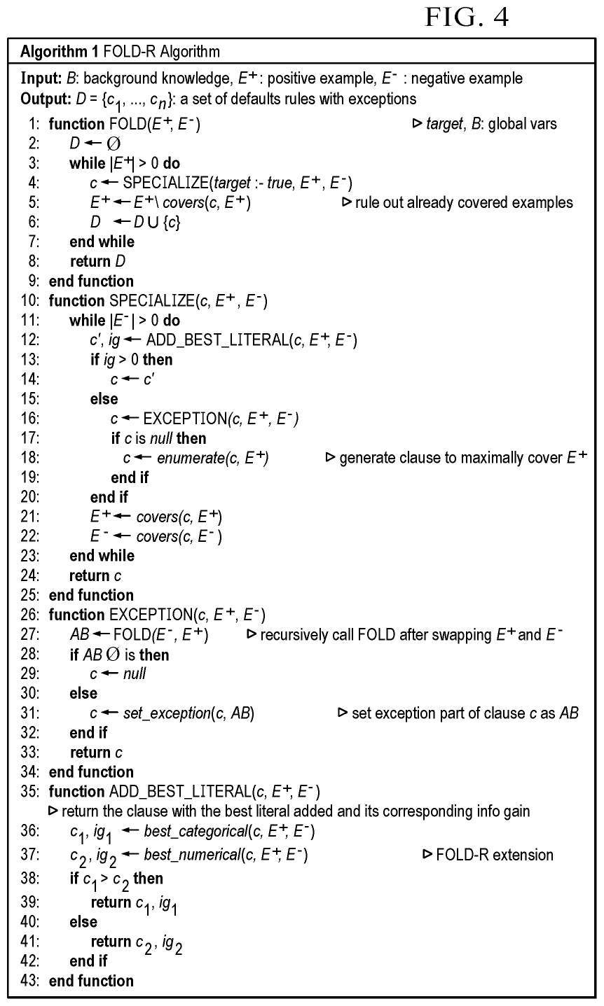

The FOLD algorithm is a top-down ILP algorithm that searches for best literals to add to the body of the clauses for hypothesis, H, with the guidance of an information gain-based heuristic. The FOLD-R algorithm is a numeric extension of the FOLD algorithm that adopts the approach of the well-known C4.5 algorithm for finding literals. Algorithm 1 shown in FIG. 4 gives an overview of the FOLD-R algorithm. The extended algorithm will directly select the best numerical literal, in addition to selecting the categorical literals. Thus, the best numerical function (line 37 in Algorithm 1) finds the best numerical literal and adds it to the clause after classifying all the training examples for each numerical split on all the features. The other functions remain the same as the FOLD algorithm. We illustrate the FOLD-R algorithm through an example.

Example 1 In the FOLD-R algorithm, the target is to learn rules for fly(X). B,E⁺,E⁻ are background knowledge, positive and negative examples, respectively.

B: bird(X):—penguin(X).

bird(tweety). bird(et).

cat(kitty). penguin(polly).

E+: fly(tweety). fly(et).

E−: fly(kitty). fly(polly).

The target predicate {fly(X):—true.} is specified when calling the specialize function at line 4 in Algorithm 1. The add best literal function selects the literal bird(X) as a result and adds it to the clause r=fly(X):—bird(X) because it has the best information gain among {bird,penguin,cat} at line 12. Then, the training set gets updated to E⁺={tweety, et}, E⁻={polly} at line 21-22 in SPECIALIZE function. The negative example polly is still falsely implied by the generated clause. The default learning of SPECIALIZE function is finished because the information gain of candidate literal c′ is zero. Therefore, the exception learning starts by calling FOLD function recursively with swapped positive and negative examples, E⁺={polly}, E⁻={tweety, et} at line 27. In this case, an abnormal predicate {ab0(X):—penguin(X)} is generated and returned as the only exception to the previous learned clause as r=fly(X):—bird(X), not ab0(X). The abnormal rule {ab0(X) :—penguin(X)} is added to the final rule set producing the program below:
fly(X):—bird(X), not ab0(X).
ab0(X):—penguin(X).

The FOLD-R++ algorithm refactors the FOLD-R algorithm. FOLD-R++ makes three main improvements to FOLD-R: (i) it can learn and add negated literals to the default (positive) part of the rule; in the FOLD-R algorithm negated literals can only be in the exception part, (ii) prefix sum algorithm is used to speed up computation, and (iii) a hyper parameter called ratio is introduced to control the level of nesting of exceptions. These three improvements make FOLD-R significantly more efficient.

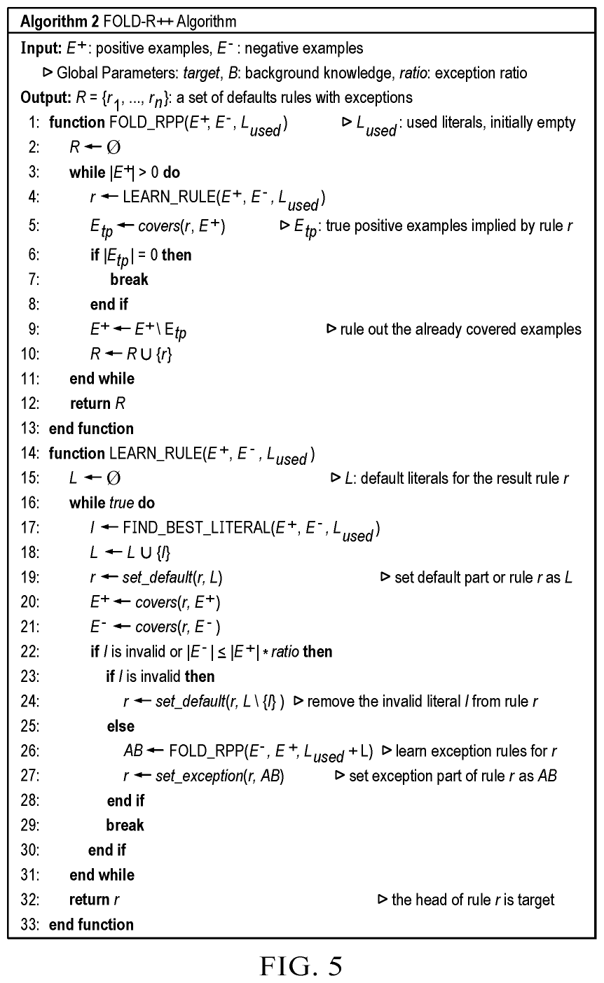

The FOLD-R++ algorithm is summarized in Algorithm 2 shown in FIG. 5. The output of the FOLD-R++ algorithm is a set of default rules coded as a normal logic program. An example implied by any rule in the set would be classified as positive. Therefore, the FOLD-R++ algorithm rules out the already covered positive examples at line 9 after learning a new rule. To learn a particular rule, the best literal would be repeatedly selected, and added to the default part of the rule's body, based on information gain using the remaining training examples (line 17). Next, only the examples that can be covered by learned default literals would be used for further learning (specializing) of the current rule (line 20-21). When the information gain becomes zero or the number of negative examples drops below the ratio threshold, the learning of the default part is done. FOLD-R++ next learns exceptions after first learning default literals. This is done by swapping the residual positive and negative examples and calling itself recursively in line 26. The remaining positive and negative examples can be swapped again and exceptions to exceptions learned (and then swapped further to learn exceptions to exceptions of exceptions, and so on). The ratio parameter in Algorithm 2 represents the ratio of training examples that are part of the exception to the examples implied by only the default conclusion part of the rule. It allows users to control the nesting level of exceptions.

Generally, avoiding falsely covering negative examples by adding literals to the default part of a rule will reduce the number of positive examples the rule can imply. Explicitly activating the exception learning procedure (line 26) could increase the number of positive examples a rule can cover while reducing the total number of rules generated. As a result, the interpretability is increased due to fewer rules and literals being generated. For the Adult Census Income dataset, for example, without the hyper-parameter exception ratio (equivalent to setting the ratio to 0), the FOLD-R++ algorithm would take around 10 minutes to finish the training and generate hundreds of rules. With the ratio parameter set to 0.5, only 13 rules are generated in around 10 seconds.

Additionally, The FOLD and FOLD-R algorithms disabled the negated literals in the default theories to make the generated rules look more elegant (only exceptions included negated literals). However, a negated literal sometimes is the optimal literal with the most useful information gain. FOLD-R++ allows for negated literals in the default part of the generated rules. We cannot make sure that FOLD-R++ generates optimal combination of literals because it is a greedy algorithm, however, it is an improvement over FOLD and FOLD-R.

The literal selection process for Shakerin's FOLD-R algorithm can be summarized as function SPECIALIZE in Algorithm 1. The FOLD-R algorithm selects the best literal based on the weighted information gain for learning defaults, similar to the original FOLD algorithm described in. For numeric features, the FOLD-R algorithm would enumerate all the possible splits. Then, it classifies the data and computes information gain for literals for each split. The literal with the best information gain would be selected as a result. In contrast, the FOLD-R++ algorithm uses a new, more efficient method employing prefix sums to calculate the information gain based on the classification categories. The FOLD-R++ algorithm divides features into two categories: categorical and numerical. All the values in a categorical feature would be considered as categorical values even if some of them are numbers. Only equality and inequality literals would be generated for categorical features. For numerical features, the FOLD-R++ algorithm would try to read each value as a number, converting it to a categorical value if the conversion fails. Additional numerical comparison (≤ and >) literal candidates would be generated for numerical features. A mixed type feature that contains both categorical and numerical values would be treated as a numerical feature.

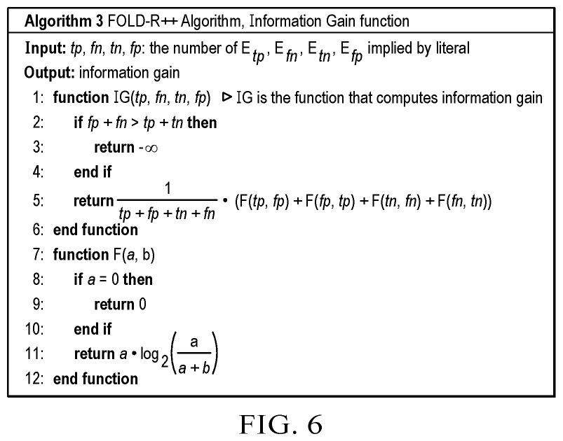

In FOLD-R++, information gain for a given literal is calculated as shown in Algorithm 3 shown in FIG. 6. The variables tp, fn, tn, fp for finding the information gain represent the numbers of true positive, false negative, true negative, and false positive examples, respectively. With the simplified information gain function IG in Algorithm 3, the new approach employs the prefix sum technique to speed up the calculation. Only one round of classification is needed for a single feature, even with mixed types of values.

In the FOLD-R++ algorithm, two types of literals would be generated: equality comparison literals and numerical comparison literals. The equality (resp. inequality) comparison is straightforward in FOLD-R++: two values are equal if they are same type and identical, else they are unequal. However, a different assumption is made for comparisons between a numerical value and categorical value in FOLD-R++. Numerical comparisons (≤ and >) between a numerical value and a categorical value is always false. A comparison example is shown in Table 1 (below), while an evaluation example for a given literal, literal(i,≤,3), based on the comparison assumption is shown in Table 1 (Right). Given E⁺={1,2,3,4,5,6,6,b}, E⁻={2,4,6,7,a}, and lateral(i,≤3), the true positive example Eₜₚ, false negative examples E_{fn}, true negative examples Eₜₙ, and false positive examples E_{fp} implied by the literal are {1,2,3,3,}, {5,6,6,b}, {2} respectively. Then, the information gain of lateral(i,≤,3) is calculated IG_{(1,≤,3)} (4,4,4,1)=−0.619 through Algorithm 3.

TABLE 1
Left: Comparison between a numerical
value and a categorial value. Right:
Evaluation and count for literal(i, ≤, 3).

| comparison | evaluation | | i^{th} feature values | count |
|---|---|---|---|---|
| 3 = ‘a’ | False | E⁺ | 1 2 3 3 5 6 6 b | 8 |
| 3 ≠ ‘a’ | True | E⁻ | 2 4 6 7 a | 5 |
| 3 ≤ ‘a’ | False | E_{tp(i, ≤, 3)} | 1 2 3 3 | 4 |
| 3 > ‘a’ | False | E_{fn(i, ≤} [symbol] ₃₎ | 5 6 6 b | 4 |
| | | E_{tn(i, ≤, 3)} | 4 6 7 a | 4 |
| | | E_{fp(i, ≤, 3)} | 2 | 1 |

[symbol]

indicates data missing or illegible when filed

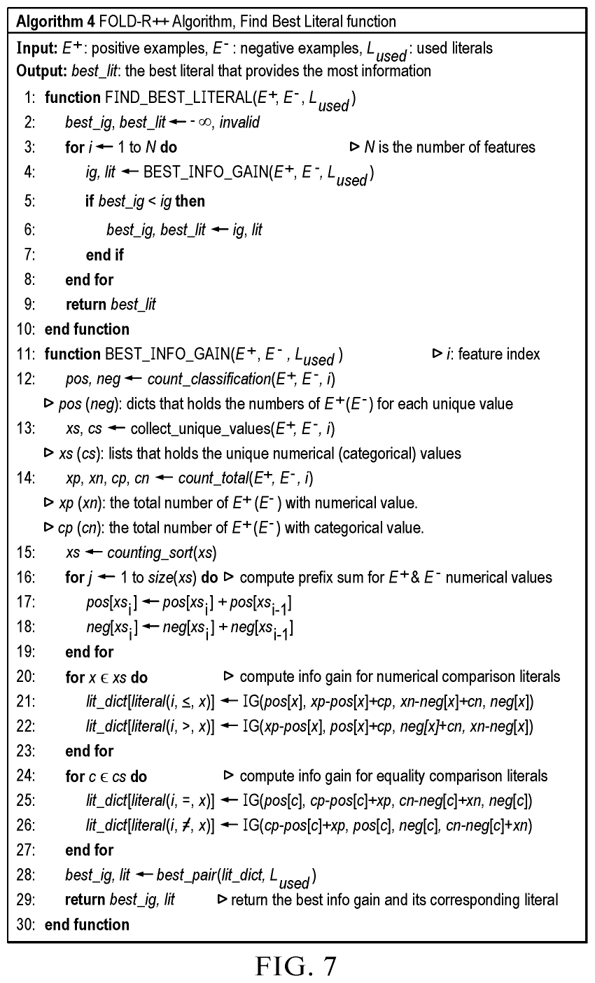

The new approach to find the best literal that provides most useful information is summarized in Algorithm 4. In line 12, pos (neg) is the dictionary that holds the numbers of positive (negative) examples for each unique value. In line 13, xs (cs) is the list that holds the unique numerical (categorical) values. In line 14, xp (xn) is the total number of positive (negative) examples with numerical values; cp (cn) is the total number of positive (negative) examples with categorical values. After computing the prefix sum at line 16, pos[x] (neg[x]) holds the total number of positive (negative) examples that have a value less than or equal to x. Therefore, xp−pos[x](xn−neg[x]) represents the total number of positive (negative) examples that have a value greater than x. In line 21, the information gain of literal(i,≤,3) is calculated by calling Algorithm 3. Note that pos[x] (neg[x]) is the actual value for the formal parameter tp (fp) of function IG in Algorithm 3. Likewise, xp−pos[x]+cp(xn−neg[x]+cn) substitute for formal parameter fn (tn) of the function IG. Cp (cn) is included in the actual parameter for formal parameter fn (tn) of function IG because of the assumption that any numerical comparison between a numerical value and a categorical value is false. The information gain calculation processes of other literals also follow the comparison assumption mentioned above. Finally, the best info gain function (see Algorithm 4 in FIG. 7) returns the best score on information gain and the corresponding literal except the literals that have been used in current rule-learning process. For each feature, we compute the best literal, then the find best literal function returns the best literal among this set of best literals. FOLD-R algorithm selects only positive literals in default part of rules during literal selection even if a negative literal provides better information gain. Unlike FOLD-R, the FOLD-R++ algorithm can also select negated literals for the default part of a rule at line 26 in Algorithm 4.

It is easy to justify the O(M) complexity of information gain calculation in FOLD-R++ mentioned earlier. The time complexity of Algorithm 3 is obviously O(1). Algorithm 3 is called in line 21, 22, 25, and 26 of Algorithm 4. Line 12-15 in Algorithm 4 can be considered as the preparation process for calculating information gain and has complexity O(M), assuming that we use counting sort (complexity O(M)) with a pre-sorted list in line 15; it is easy to see that lines 16-29 take time O(N).

Example 2: Given positive and negative examples, E⁺,E⁻, with mixed type of values on feature i, the target is to find the literal with the best information gain on the given feature. There are 8 positive examples, their values on feature i are [1, 2, 3, 3, 5, 6, 6, b]. And the values on feature i of the 5 negative examples are [2, 4, 6, 7, a].

With the given examples and specified feature, the numbers of positive examples and negative examples for each unique value are counted _rst, which are shown as pos; neg at right side of Table 2. Then, the pre_x sum arrays are calculated for computing the heuristic as psum⁺, psum⁻. Table 3 shows the information gain for each literal, the literal(i,≠,a) has been selected with the highest score.

TABLE 2
Left: Examples and values on i^{th} feature.
Right: position/negative count and prefix sum on each value

| | i^{th} feature values | value | 1 | 2 | 3 | 4 | 5 | 6 | 7 | a | b |
|---|---|---|---|---|---|---|---|---|---|---|---|
| E⁺ | 1 2 3 3 5 6 6 b | pos | 1 | 1 | 2 | 0 | 1 | 2 | 0 | 0 | 1 |
| E⁻ | 2 4 6 7 a | psum⁺ | 1 | 2 | 4 | 4 | 5 | 7 | 7 | na | na |
| | | neg | 0 | 1 | 0 | 1 | 0 | 1 | 1 | 1 | 0 |
| | | psum⁻ | 0 | 1 | 1 | 2 | 2 | 3 | 4 | na | na |

TABLE 3
The info gain on i^{th} feature with given examples

| | Info Gain | | | | | | | | |
|---|---|---|---|---|---|---|---|---|---|
| value | 1 | 2 | 3 | 4 | 5 | 6 | 7 | a | b |
| ≤ value | −∞ | −∞ | −0.619 | −0.661 | −0.642 | −0.616 | −0.661 | na | na |
| > value | −0.664 | −0.666 | −∞ | −∞ | −∞ | −∞ | −∞ | na | na |
| = value | na | na | na | na | na | na | na | −∞ | −∞ |
| ≠ value | na | na | na | na | na | na | na | −0.588 | −0.627 |

The illustrative embodiment may also apply a gini impurity heuristic to prune rules during training. As the training process of the FOLD-R++/FOLD-RM algorithms proceeds, the generated rules cover fewer examples than the earlier generated ones. In other words, the FOLD-R++& FOLD-RM algorithms can suffer from the long-tail effect. Therefore, the illustrative embodiments add a hyperparameter to limit the minimum number/percentage of training examples that a rule can cover.

The gini impurity heuristic can be expressed:

$$M G I ( {p}_{1} , {n}_{1} , {p}_{2} , {n}_{2} , … , {p}_{m} , {n}_{m} ) = - ( {\sum }_{i = 1}^{m} \sqrt{( {\sum }_{j = 1}^{m} {p}_{j} - {p}_{i} ) \times {p}_{i}} + {\sum }_{i = 1}^{m} \sqrt{( {\sum }_{j = 1}^{m} {n}_{j} - {n}_{i} ) \times {n}_{i}} ) \div {\sum }_{i = 1}^{m} ( {p}_{i} + {n}_{i} )$$

where pᵢ,nᵢ denote the number of positive prediction and the number of negative predictions for the examples of classᵢ for binary splitting.

For binary classification tasks:

MGI(tp,fn,tn,fp)=−(\sqrt{tp×fp}+\sqrt{tn×fn})+(tp+fn+tn+fp)

where tp, fn, tn, fp are the number of true positive, false negative, true negative, and false positive predicting examples for binary classification.

This hyperparameter helps reduce the number of generated rules and generate literals by reducing the overfitting of outliers. This pruning process is not a post-process after training but rather prunes the learned rules during the training process and accelerates the training.

Explainability is very important for some tasks like loan approval, credit card approval, and disease diagnosis system. Inductive logic programming provides explicit rules for how a prediction is generated compared to black box models like those based on neural networks. To efficiently justify the prediction, the FOLD-R++ outputs normal logic programs that are compatible with the s(CASP) goal-directed answer set programming system. The s(CASP) system executes answer set programs in a goal-directed manner. Stratified normal logic programs output by FOLD-R++ are a special case of answer set programs.

Example 3: The “Adult Census Income” is a classical classification task that contains 32561 records. We treat 80% of the data as training examples and 20% as testing examples. The task is to learn the income status of individuals (more/less than 50K/year) based on features such as gender, age, education, marital status, etc. FOLD-R++ generates the following program that contains only 13 rules:
(1) income(X,‘=<50k’):—not marital status(X,‘married-civ-spouse’), not ab4(X), not ab5(X).
(2) income(X,‘=<50k’):—education num(X,N4), N4=<12.0, capital gain(X,N10), N10=<5013.0, not ab6(X), not ab8(X).
(3) income(X,‘=<50k’) occupation(X,‘farming-fishing’), age(X,N0), N0>62.0, N0=<63.0, education num(X,N4), N4>12.0, capital gain(X,N10), N10>5013.0.
(4) income(X,‘=<50k’) age(X,N0), N0>65.0, education num(X,N4), N4>12.0, capital gain(X,N10), N10>9386.0, N10=<10566.0.
(5) income(X,‘=<50k’) age(X,N0), N0>35.0, fnlwgt(X,N2), N2>199136.0, education num(X,N4), N4>12.0, capital gain(X,N10), N10>5013.0, hours per week(X,N12), N12=<20.0.
(6) ab1(X):—age(X,N0), N0=<20.0.
(7) ab2(X):—education num(X,N4), N4=<10.0, capital gain(X,N10), N10=<7978.0.
(8) ab3(X):—capital gain(X,N10), N10>27828.0, N10=<34095.0.
(9) ab4(X):—capital gain(X,N10), N10>6849.0, not ab1(X), not ab2(X), not ab3(X).
(10) ab5(X):—age(X,N0), N0=<27.0, education num(X,N4), N4>12.0, capital loss(X,N11), N11>1974.0, N11=<2258.0.
(11) ab6(X):—not marital status(X,‘married-civ-spouse’).
(12) ab7(X):—occupation(X,‘transport-moving’), age(X,N0), N0>39.0.
(13) ab8(X):—education num(X,N4), N4=<8.0, capital loss(X,N11), N11>1672.0, N11=<1977.0, not ab7(X).

The above program achieves 0.86 accuracy, 0.88 precision, 0.95 recall, and 0.91 F1 score. Given a new data sample, the predicted answer for this data sample using the above logic program can be efficiently produced by the s(CASP) system. Since s(CASP) is query driven, an example query such as ?—income(30, Y) which checks the income status of the person with ID 30, will succeed if the income is indeed predicted as less equal to 50K by the model represented by the logic program above.

The s(CASP) system will also produce a justification (a proof tree) for this prediction query. It can even generate this proof tree in English, i.e., in a more human understandable form. The justification tree generated for the person with ID 30 is shown below:
?—income(30,Y).
% QUERY:I would like to know if
‘income’ holds (for 30, and Y).
ANSWER: 1 (in 2.246 ms)

JUSTIFICATION_TREE:
‘income’ holds (for 30, and ‘=<50k’), because
there is no evidence that ‘marital status’ holds (for 30, and married-civ-spouse), and
there is no evidence that ‘ab4’ holds (for 30), because there is no evidence that ‘capital gain’ holds (for 30, and Var1), with Var1 not equal 0.0, and ‘capital gain’ holds (for 30, and 0.0).
there is no evidence that ‘ab5’ holds (for 30), because there is no evidence that ‘age’ holds (for 30, and Var2), with Var2 not equal 18.0, and ‘age’ holds (for 30, and 18.0), and there is no evidence that ‘education num’ holds (for 30, and Var3), with Var3 not equal 7.0, and ‘age’ holds (for 30, and 18.0), justified above, and ‘education num’ holds (for 30, and 7.0).

The global constraints hold.

BINDINGS:

Y equal ‘=<50k’

With the justification tree, the reason for the prediction can be easily understood by human beings. The generated NLP rule-set can also be understood by a human. If there is any unreasonable logic generated in the rule set, it can also be modified directly by the human without retraining. Thus, any bias in the data that is captured in the generated NLP rules can be corrected by the human user, and the updated NLP rule-set used for making new predictions.

The RIPPER system is a well-known rule-induction algorithm that generates formulas in conjunctive normal form (CNF) as an explanation of the model. RIPPER generates 53 formulas for Example 3 and achieves 0.61 accuracy, 0.98 precision, 0.50 recall, and 0.66 F1 score. A few of the fifty three rules generated by RIPPER for this dataset are shown below.
(1) marital_status=Never-married & education_num=7.0-9.0 & workclass=Private & hours_per_week=35.0-40.0 & capital_gain=<9999.9 & sex=Female
(2) marital_status=Never-married & capital_gain=<9999.9 & education_num=7.0-9.0 & hours_per_week=35.0-40.0 & relationship=Own-child
(3) marital_status=Never-married & capital_gain=<9999.9 & education_num=7.0-9.0 & hours_per_week=35.0-40.0 & race=White & age=22.0-26.0
(4) marital_status=Never-married & capital_gain=<9999.9 & education_num=7.0-9.0 & hours_per_week=24.0-35.0
(50) education_num=7.0-9.0 & age=26.0-30.0 & fnlwgt=177927.0-196123.0 & workclass=Private
(51) relationship=Not-in-family & capital_gain=<9999.9 & hours_per_week=35.0-40.0 & sex=Female & education=Assoc-voc
(52) education_num=<7.0 & workclass=Private & fnlwgt=260549.8-329055.0
(53) relationship=Not-in-family & capital_gain=<9999.9 & hours_per_week=35.0-40.0 & education_num=11.0-13.0 & occupation=Adm-clerical

Generally, a set of default rules is a more succinct description of a given concept compared to a set of CNFs, especially when nested exceptions are allowed in the default rules. For this reason, we believe that FOLD-R++ performs better than RIPPER on large datasets, as shown later.

In this section, we present our experiments on UCI standard benchmarks. The XGBoost Classifier is a popular classification model and used as a baseline in our experiment. We used simple settings for XGBoost classifier without limiting its performance. However, XGBoost cannot deal with mixed type (numerical and categorical) of examples directly. One-hot encoding has been used for data preparation. We use precision, recall, accuracy, F1 score, and execution time to compare the results.

FOLD-R++ does not require any encoding before training. We implemented FOLD-R++ with Python (the original FOLD-R implementation is in Java). To make inferences using the generated rules, we developed a simple logic programming interpreter for our application that is part of the FOLD-R++ system. Note that the generated programs are stratified, so implementing an interpreter for such a restricted class in Python is relatively easy. However, for obtaining the justification/proof tree, or for translating the NLP rules into equivalent English text, one must use the s(CASP) system.

The time complexity for computing information gain on a feature is significantly reduced in FOLD-R++ due to the use of prefix-sum, resulting in rather large improvements in efficiency. For the credit-a dataset with only 690 instances, the new FOLD-R++ algorithm is a hundred times faster than the original FOLD-R. The hyper-parameter ratio is simply set as 0.5 for all the experiments. All the learning experiments have been conducted on a desktop with Intel i5-10400 CPU@2.9 GHz and 32 GB ram. To measure performance metrics, we conducted 10-fold cross-validation on each dataset and the average of accuracy, precision, recall, F1 score and execution time are presented (Table 4, Table 5, Table 6). The best performer is highlighted in boldface.

TABLE 4
Comparison of FOLD-R and FOLD-R++ on various Datasets

| Data Set | | | FOLD-R | | | | |
|---|---|---|---|---|---|---|---|
| Name | #Rows | #Cols | Acc. | Prec. | Rec. | F1 | T(ms) |
| acute | 120 | 7 | 0.99 | 1 | 0.98 | 0.99 | 12 |
| autism | 704 | 18 | 0.95 | 0.97 | 0.97 | 0.96 | 321 |
| breast-w | 699 | 10 | 0.95 | 0.96 | 0.96 | 0.96 | 373 |
| cars | 1728 | 7 | 0.99 | 0.99 | 1 | 0.99 | 134 |
| credit-a | 690 | 16 | 0.82 | 0.83 | 0.85 | 0.84 | 11,316 |
| ecoli | 336 | 9 | 0.93 | 0.92 | 0.92 | 0.91 | 686 |
| heart | 270 | 14 | 0.74 | 0.75 | 0.80 | 0.77 | 888 |
| ionosphere | 351 | 35 | 0.89 | 0.90 | 0.93 | 0.91 | 9,297 |
| kidney | 400 | 25 | 0.98 | 0.99 | 0.98 | 0.99 | 451 |
| kr vs. kp | 3196 | 37 | 0.99 | 0.99 | 0.99 | 0.99 | 1,259 |
| mushroom | 8124 | 23 | 1 | 1 | 1 | 1 | 1,556 |
| voting | 435 | 17 | 0.95 | 0.93 | 0.94 | 0.93 | 96 |
| adult | 32561 | 15 | 0.77 | 0.94 | 0.74 | 0.83 | 4+ days |
| credit card | 30000 | 24 | 0.64 | 0.87 | 0.63 | 0.73 | 24+ days |
| Data Set | FOLD-R | FOLD-R++ | | | | | |
| Name | #Rules | Acc. | Prec. | Rec. | F1 | T(ms) | #Rules |
| acute | 2.0 | 0.99 | 1 | 0.99 | 0.99 | 2.3 | 2.6 |
| autism | 18.4 | 0.93 | 0.96 | 0.95 | 0.95 | 62 | 24.3 |
| breast-w | 11.2 | 0.95 | 0.97 | 0.95 | 0.96 | 32 | 10.2 |
| cars | 17.9 | 0.97 | 1 | 0.97 | 0.98 | 50 | 12.2 |
| credit-a | 33.4 | 0.85 | 0.92 | 0.79 | 0.85 | 111 | 10.0 |
| ecoli | 7.7 | 0.94 | 0.95 | 0.92 | 0.93 | 34 | 11.4 |
| heart | 15.9 | 0.79 | 0.80 | 0.83 | 0.80 | 40 | 11.7 |
| ionosphere | 5.9 | 0.91 | 0.93 | 0.93 | 0.93 | 385 | 12.0 |
| kidney | 5.7 | 0.99 | 1 | 0.98 | 0.99 | 28 | 5.0 |
| kr vs. kp | 16.8 | 0.99 | 0.99 | 0.99 | 0.99 | 319 | 18.4 |
| mushroom | 8.6 | 1 | 1 | 1 | 1 | 523 | 8.0 |
| voting | 13.7 | 0.95 | 0.92 | 0.95 | 0.93 | 16 | 10.5 |
| adult | 595.5 | 0.84 | 0.86 | 0.95 | 0.90 | 10,066 | 16.7 |
| credit card | 514.9 | 0.82 | 0.83 | 0.96 | 0.89 | 21,349 | 19.1 |

Experiments reported in Table 4 are based on our re-implementation of FOLD-R in Python. The Python re-implementation is 6 to 10 times faster than Shakerin's original Java implementation according to the common tested datasets. However, the re-implementation still lacks efficiency on large datasets due to the original design. The FOLD-R experiments on the Adult Census Income and the Credit Card Approval datasets are performed with improvements in heuristic calculation while for other datasets the method of calculation remains as in Shakerin's original design. In these two cases, the efficiency improves significantly but the output is identical to original FOLD-R. The average execution time of these two datasets is still quite large, however, we use polynomial regression to estimate it. The estimated average execution time of the Adult Census Income dataset ranges from 4 to 7 days, and a random single test took 4.5 days. The estimated execution time of the Credit Card Approval dataset ranges from 24 to 55 days. For small datasets, the classification performance are similar, however, wrt execution time, the FOLD-R++ algorithm is order of magnitude faster than (the re-implemented Python version of) FOLD-R. For large datasets, FOLD-R++ significantly improves the efficiency, classification performance, and explainability over FOLD-R. For the Adult Census Income and the Credit Card Approval datasets, the average number of rules generated by FOLD-R are over 500 while the number for FOLD-R++ is less than 20.

TABLE 5
Comparison of RIPPER and FOLD-R++ on various Datasets

| Data Set | | | RIPPER | | | | |
|---|---|---|---|---|---|---|---|
| Name | #Rows | #Cols | Acc. | Prec. | Rec. | F1 | T(ms) |
| acute | 120 | 7 | 0.93 | 1 | 0.84 | 0.91 | 73 |
| autism | 704 | 18 | 0.93 | 0.96 | 0.95 | 0.95 | 444 |
| breast-w | 699 | 10 | 0.91 | 0.97 | 0.89 | 0.93 | 267 |
| cars | 1728 | 7 | 0.99 | 0.99 | 0.99 | 0.99 | 379 |
| credit-a | 690 | 16 | 0.89 | 0.94 | 0.86 | 0.90 | 972 |
| ecoli | 336 | 9 | 0.90 | 0.91 | 0.86 | 0.88 | 494 |
| heart | 270 | 14 | 0.73 | 0.82 | 0.69 | 0.72 | 338 |
| ionosphere | 351 | 35 | 0.81 | 0.85 | 0.86 | 0.85 | 1,431 |
| kidney | 400 | 25 | 0.98 | 0.99 | 0.98 | 0.99 | 451 |
| kr vs. kp | 3196 | 37 | 0.99 | 0.99 | 0.99 | 0.99 | 553 |
| mushroom | 8124 | 23 | 1 | 1 | 1 | 1 | 795 |
| voting | 435 | 17 | 0.94 | 0.92 | 0.92 | 0.92 | 146 |
| adult | 32561 | 15 | 0.70 | 0.96 | 0.63 | 0.76 | 59,505 |
| credit card | 30000 | 24 | 0.77 | 0.87 | 0.83 | 0.85 | 47,422 |
| rain in aus | 145460 | 24 | 0.65 | 0.93 | 0.57 | 0.71 | 2,850,997 |
| Data Set | RIPPER | FOLD-R++ | | | | | |
| Name | #Rules | Acc. | Prec. | Rec. | F1 | T(ms) | #Rules |
| acute | 2.0 | 0.99 | 1 | 0.99 | 0.99 | 2.3 | 2.6 |
| autism | 9.6 | 0.93 | 0.96 | 0.95 | 0.95 | 62 | 24.3 |
| breast-w | 7.7 | 0.95 | 0.97 | 0.95 | 0.96 | 32 | 10.2 |
| cars | 15.4 | 0.97 | 1 | 0.97 | 0.98 | 50 | 12.2 |
| credit-a | 11.1 | 0.85 | 0.92 | 0.79 | 0.85 | 111 | 10.0 |
| ecoli | 8.0 | 0.94 | 0.95 | 0.92 | 0.93 | 34 | 11.4 |
| heart | 6.2 | 0.79 | 0.80 | 0.83 | 0.80 | 40 | 11.7 |
| ionosphere | 9.9 | 0.91 | 0.93 | 0.93 | 0.93 | 385 | 12.0 |
| kidney | 5.7 | 0.99 | 1 | 0.98 | 0.99 | 28 | 5.0 |
| kr vs. kp | 8.1 | 0.99 | 0.99 | 0.99 | 0.99 | 319 | 18.4 |
| mushroom | 8.0 | 1 | 1 | 1 | 1 | 523 | 8.0 |
| voting | 4.3 | 0.95 | 0.92 | 0.95 | 0.93 | 16 | 10.5 |
| adult | 46.9 | 0.84 | 0.86 | 0.95 | 0.90 | 10,066 | 16.7 |
| credit card | 38.4 | 0.82 | 0.83 | 0.96 | 0.89 | 21,349 | 19.1 |
| rain in aus | 175.4 | 0.78 | 0.87 | 0.84 | 0.85 | 223,116 | 40.5 |

The RIPPER system is another rule-induction algorithm that generates formulas in conjunctive normal form as an explanation of the model. As Table 5 shows, FOLD-R++ system's performance is comparable to RIPPER, however, it signi_cantly outperforms RIPPER on large datasets (Rain in Australia [taken from Kaggle], Adult Census Income, Credit Card Approval). FOLD-R++ generates much smaller numbers of rules for these large datasets.

TABLE 6
Comparison of XGBoost and FOLD-R++ on various Datasets

| Data Set | | | XGBoost. Classifier | | | | | FOLD-R++ | | | | |
|---|---|---|---|---|---|---|---|---|---|---|---|---|
| Name | #Rows | #Cols | Acc. | Prec. | Rec. | F1 | T(ms) | Acc. | Prec. | Rec. | F1 | T(ms) |
| acute | 120 | 7 | 1 | 1 | 1 | 1 | 35 | 0.99 | 1 | 0.99 | 0.99 | 2.5 |
| autism | 704 | 18 | 0.97 | 0.98 | 0.98 | 0.97 | 76 | 0.95 | 0.96 | 0.97 | 0.97 | 47 |
| breast-w | 699 | 10 | 0.95 | 0.97 | 0.96 | 0.96 | 78 | 0.96 | 0.97 | 0.96 | 0.97 | 28 |
| cars | 1728 | 7 | 1 | 1 | 1 | 1 | 77 | 0.98 | 1 | 0.97 | 0.98 | 48 |
| credit-a | 690 | 16 | 0.85 | 0.83 | 0.83 | 0.83 | 368 | 0.84 | 0.92 | 0.79 | 0.84 | 100 |
| ecoli | 336 | 9 | 0.76 | 0.76 | 0.62 | 0.68 | 165 | 0.96 | 0.95 | 0.94 | 0.95 | 28 |
| heart | 270 | 14 | 0.80 | 0.81 | 0.83 | 0.81 | 112 | 0.79 | 0.79 | 0.83 | 0.81 | 44 |
| ionosphere | 351 | 35 | 0.88 | 0.86 | 0.96 | 0.90 | 1,126 | 0.92 | 0.93 | 0.94 | 0.93 | 392 |
| kidney | 400 | 25 | 0.98 | 0.98 | 0.98 | 0.98 | 126 | 0.99 | 1 | 0.98 | 0.99 | 27 |
| kr vs. kp | 3196 | 37 | 0.99 | 0.99 | 0.99 | 0.99 | 210 | 0.99 | 0.99 | 0.99 | 0.99 | 361 |
| mushroom | 8124 | 23 | 1 | 1 | 1 | 1 | 378 | 1 | 1 | 1 | 1 | 476 |
| voting | 435 | 17 | 0.95 | 0.94 | 0.95 | 0.94 | 49 | 0.95 | 0.94 | 0.94 | 0.94 | 16 |
| adult | 32561 | 15 | 0.86 | 0.88 | 0.94 | 0.91 | 274,665 | 0.84 | 0.86 | 0.95 | 0.90 | 10,069 |
| credit card | 30000 | 24 | — | — | — | — | — | 0.82 | 0.83 | 0.96 | 0.89 | 21,349 |
| rain in aus | 145460 | 24 | 0.83 | 0.84 | 0.95 | 0.89 | 285,307 | 0.78 | 0.87 | 0.84 | 0.85 | 279,320 |

Performance of the XGBoost system and FOLD-R++ is compared in table 6. The XGBoost Classifier employs a decision tree ensemble method for classification tasks and provides quite good performance. FOLD-R++ almost always spends less time to finish learning compared to XGBoost classifier, especially for the (large) Adult income census dataset where numerical features have many unique values. For most datasets, FOLD-R++ can achieve equivalent scores. FOLD-R++ achieves higher scores on ecoli dataset. For the credit card dataset, the baseline XGBoost model failed training due to 32 GB memory limitation, but FOLD-R++ performed well.

Tables 7, 8, and 9 depict results obtain by employing a gini impurity heuristic instead of information gain. The new algorithm employing gini impurity is called FOLD-SE, wherein SE stands for scalable explainability. NA in Table 9 indicates that they need too much memory for one-hot encoding that was beyond the testing machine.

TABLE 7
Comparison of RIPPER and FOLD-SE on various Datasets

| Data Set | | | RIPPER | | | | | |
|---|---|---|---|---|---|---|---|---|
| Name | #Rows | #Cols | Acc. | Prec. | Rec. | F1 | T(ms) | #Rules |
| acute | 120 | 7 | 0.93 | 1 | 0.85 | 0.92 | 95 | 2.0 |
| heart | 270 | 14 | 0.76 | 0.79 | 0.78 | 0.77 | 317 | 5.4 |
| ionosphere | 351 | 35 | 0.72 | 0.88 | 0.67 | 0.73 | 1,161 | 8.5 |
| kidney | 400 | 25 | 0.98 | 1.0 | 0.97 | 0.98 | 750 | 7.1 |
| voting | 435 | 17 | 0.95 | 0.93 | 0.93 | 0.92 | 172 | 4.1 |
| credit-a | 690 | 16 | 0.89 | 0.93 | 0.86 | 0.89 | 944 | 10.1 |
| breast-w | 699 | 10 | 0.93 | 0.94 | 0.88 | 0.90 | 319 | 14.4 |
| autism | 704 | 18 | 0.93 | 0.95 | 0.96 | 0.95 | 359 | 10.3 |
| parkinson | 765 | 754 | 0.70 | 0.88 | 0.70 | 0.78 | 189,556 | 8.9 |
| cars | 1728 | 7 | 0.99 | 0.99 | 0.99 | 0.99 | 385 | 14.2 |
| kr vs. kp | 3196 | 37 | 0.99 | 0.99 | 0.99 | 0.99 | 609 | 8.1 |
| mushroom | 8124 | 23 | 1 | 1 | 1 | 1 | 923 | 8.3 |
| intention | 12330 | 18 | 0.88 | 0.95 | 0.90 | 0.93 | 8,542 | 25.2 |
| eeg | 14980 | 15 | 0.55 | 0.87 | 0.23 | 0.36 | 12,996 | 43.4 |
| credit card | 30000 | 24 | 0.76 | 0.87 | 0.81 | 0.84 | 49,940 | 36.5 |
| adult | 32561 | 15 | 0.71 | 0.95 | 0.65 | 0.77 | 63,480 | 41.4 |
| rain in aus | 145460 | 24 | 0.63 | 0.94 | 0.55 | 0.70 | 3118,025 | 180.1 |
| Data Set | FOLD-SE | | | | | | | |
| Name | #Preds | Acc. | Prec. | Rec. | F1 | T(ms) | #Rules | #Preds |
| acute | 4.0 | 3.0 | 1.0 | 1.0 | 1.0 | 1 | 2.0 | 3.0 |
| heart | 12.9 | 0.74 | 0.77 | 0.78 | 0.77 | 13 | 4.0 | 9.1 |
| ionosphere | 13.9 | 0.91 | 0.89 | 0.98 | 0.93 | 119 | 3.6 | 7.1 |
| kidney | 8.5 | 1.0 | 1.0 | 1.0 | 1.0 | 16 | 4.9 | 6.1 |
| voting | 8.9 | 1.95 | 0.92 | 0.96 | 0.94 | 11 | 7.3 | 20.2 |
| credit-a | 21.4 | 0.85 | 0.92 | 0.79 | 0.85 | 36 | 2.4 | 5.8 |
| breast-w | 19.9 | 0.94 | 0.88 | 0.97 | 0.92 | 9 | 3.5 | 6.3 |
| autism | 25.2 | 0.91 | 0.94 | 0.94 | 0.94 | 29 | 9.9 | 23.6 |
| parkinson | 13.4 | 0.82 | 0.82 | 0.96 | 0.89 | 9,691 | 5.7 | 12.5 |
| cars | 39.8 | 0.96 | 1.0 | 0.94 | 0.97 | 20 | 7.2 | 14.0 |
| kr vs. kp | 16.2 | 0.97 | 0.96 | 0.97 | 0.97 | 152 | 5.0 | 10.4 |
| mushroom | 12.7 | 1.0 | 1.0 | 0.99 | 1.0 | 254 | 5.7 | 10.6 |
| intention | 91.6 | 0.90 | 0.95 | 0.93 | 0.94 | 661 | 2.0 | 5.1 |
| eeg | 134.7 | 0.67 | 0.74 | 0.63 | 0.68 | 1,227 | 5.1 | 12.1 |
| credit card | 150.7 | 0.82 | 0.83 | 0.96 | 0.89 | 3,513 | 2.0 | 3.0 |
| adult | 168.4 | 0.84 | 0.86 | 0.95 | 0.90 | 1,746 | 2.0 | 5.0 |
| rain in aus | 776.4 | 0.82 | 0.85 | 0.94 | 0.89 | 10,243 | 2.5 | 6.1 |

TABLE 8
Comparison of FOLD-R++ and FOLD-SE on various Datasets

| Data Set | | | FOLD-R++ | | | | | |
|---|---|---|---|---|---|---|---|---|
| Name | #Rows | #Cols | Acc. | Prec. | Rec. | F1 | T(ms) | Rules# |
| acute | 120 | 7 | 0.99 | 1 | 0.99 | 0.99 | 2 | 2.7 |
| heart | 270 | 14 | 0.77 | 0.80 | 0.80 | 0.79 | 38 | 15.9 |
| ionosphere | 351 | 35 | 0.90 | 0.92 | 0.93 | 0.92 | 275 | 12.4 |
| kidney | 400 | 25 | 0.99 | 1.0 | 0.98 | 0.99 | 16 | 4.9 |
| voting | 435 | 17 | 0.94 | 0.92 | 0.93 | 0.92 | 23 | 10.0 |
| credit-a | 690 | 16 | 0.83 | 0.90 | 0.78 | 0.83 | 84 | 10.3 |
| breast-w | 699 | 10 | 0.95 | 0.97 | 0.85 | 0.96 | 34 | 10.5 |
| autism | 704 | 18 | 0.93 | 0.95 | 0.95 | 0.95 | 62 | 25.4 |
| parkinson | 765 | 754 | 0.82 | 0.85 | 0.93 | 0.89 | 10,757 | 13.7 |
| cars | 1728 | 7 | 0.96 | 1.0 | 0.95 | 0.97 | 31 | 12.3 |
| kr vs. kp | 3196 | 37 | 0.99 | 1.0 | 0.99 | 0.99 | 226 | 19.3 |
| mushroom | 8124 | 23 | 1 | 1 | 1 | 1 | 281 | 7.9 |
| intention | 12330 | 18 | 0.90 | 0.95 | 0.93 | 0.94 | 1,085 | 8.4 |
| eeg | 14980 | 15 | 0.72 | 0.76 | 0.72 | 0.74 | 2,735 | 69.1 |
| credit card | 30000 | 24 | 0.82 | 0.83 | 0.96 | 0.89 | 5,954 | 19.1 |
| adult | 32561 | 15 | 0.84 | 0.86 | 0.95 | 0.90 | 2,508 | 16.8 |
| rain in aus | 145460 | 24 | 0.79 | 0.87 | 0.84 | 0.86 | 26,203 | 48.2 |
| Data Set | FOLD-R++ | FOLD-SE | | | | | | |
| Name | #Preds | Acc. | Prec. | Rec. | F1 | T(ms) | #Rules | #Preds |
| acute | 3.0 | 1.0 | 1.0 | 1.0 | 1.0 | 1 | 2.0 | 3.0 |
| heart | 32.2 | 0.74 | 0.77 | 0.78 | 0.77 | 13 | 4.0 | 9.1 |
| ionosphere | 19.7 | 0.91 | 0.89 | 0.98 | 0.93 | 119 | 3.6 | 7.1 |
| kidney | 5.9 | 1.0 | 1.0 | 1.0 | 1.0 | 16 | 4.9 | 6.1 |
| voting | 27.2 | 0.95 | 0.92 | 0.96 | 0.94 | 11 | 7.3 | 20.2 |
| credit-a | 23.3 | 0.85 | 0.92 | 0.79 | 0.85 | 36 | 2.4 | 5.8 |
| breast-w | 18.6 | 0.94 | 0.88 | 0.97 | 0.92 | 9 | 3.5 | 6.3 |
| autism | 54.8 | 0.91 | 0.94 | 0.94 | 0.94 | 29 | 9.9 | 23.6 |
| parkinson | 21.2 | 0.82 | 0.82 | 0.96 | 0.89 | 9,691 | 5.7 | 12.5 |
| cars | 29.8 | 0.96 | 1.0 | 0.94 | 0.97 | 20 | 7.2 | 14.0 |
| kr vs. kp | 46.7 | 0.97 | 0.96 | 0.97 | 0.97 | 152 | 5.0 | 10.4 |
| mushroom | 11.9 | 1.0 | 1.0 | 0.99 | 1.0 | 254 | 5.7 | 10.6 |
| intention | 23.0 | 0.90 | 0.95 | 0.93 | 0.94 | 661 | 2.0 | 5.1 |
| eeg | 152.6 | 0.67 | 0.74 | 0.63 | 0.68 | 1,227 | 5.1 | 12.1 |
| credit card | 48.8 | 0.82 | 0.83 | 0.96 | 0.89 | 3,513 | 2.0 | 3.0 |
| adult | 46.7 | 0.84 | 0.86 | 0.95 | 0.90 | 1,746 | 2.0 | 5.0 |
| rain in aus | 115.8 | 0.82 | 0.85 | 0.94 | 0.89 | 10,243 | 2.5 | 6.1 |

TABLE 9
Comparison of XGBoost, MLP, and FOLD-SE on various Datasets

| Data Set | | | XGBoost | | | | | MLP | |
|---|---|---|---|---|---|---|---|---|---|
| Name | #Rows | #Cols | Acc. | Prec. | Rec. | F1 | T(ms) | Acc. | Prec. |
| acute | 120 | 7 | 1.0 | 1.0 | 1.0 | 1.0 | 122 | 0.99 | 1 |
| heart | 270 | 14 | 0.82 | 0.83 | 0.85 | 0.83 | 247 | 0.76 | 0.79 |
| ionosphere | 351 | 35 | 0.88 | 0.87 | 0.95 | 0.91 | 2,206 | 0.79 | 0.91 |
| kidney | 400 | 25 | 0.99 | 0.99 | 0.99 | 0.99 | 273 | 0.99 | 1.0 |
| voting | 435 | 17 | 0.95 | 0.93 | 0.95 | 0.93 | 149 | 0.95 | 0.92 |
| credit-a | 690 | 16 | 0.85 | 0.86 | 0.86 | 0.86 | 720 | 0.82 | 0.84 |
| breast-w | 699 | 10 | 0.95 | 0.96 | 0.98 | 0.96 | 186 | 0.97 | 0.98 |
| autism | 704 | 18 | 0.97 | 0.98 | 0.98 | 0.98 | 236 | 0.96 | 0.99 |
| parkinson | 765 | 754 | 0.76 | 0.79 | 0.93 | 0.85 | 270,336 | 0.60 | 0.77 |
| cars | 1728 | 7 | 1.0 | 1.0 | 1.0 | 1.0 | 210 | 0.99 | 1.0 |
| kr vs. kp | 3196 | 37 | 0.99 | 0.99 | 1.0 | 0.99 | 403 | 0.99 | 0.99 |
| mushroom | 8124 | 23 | 1.0 | 1.0 | 1.0 | 1.0 | 697 | 1.0 | 1.0 |
| intention | 12330 | 18 | 0.90 | 0.93 | 0.95 | 0.94 | 171,480 | 0.81 | 0.89 |
| eeg | 14980 | 15 | 0.64 | 0.64 | 0.81 | 0.71 | 46,472 | 0.69 | 0.72 |
| credit card | 30000 | 24 | NA | NA | NA | NA | NA | NA | NA |
| adult | 32561 | 15 | 0.87 | 0.89 | 0.95 | 0.92 | 424,686 | 0.81 | 0.88 |
| rain in aus | 145460 | 24 | 0.84 | 0.85 | 0.96 | 0.90 | 385,456 | 0.81 | 0.86 |
| | Data Set | MLP | | | FOLD-SE | | | | |
| | Name | Rec. | F1 | T(ms) | Acc. | Prec. | Rec. | F1 | T(ms) |
| | acute | 0.99 | 0.99 | 22 | 1.0 | 1.0 | 1.0 | 1.0 | 1 |
| | heart | 0.79 | 0.78 | 95 | 0.74 | 0.77 | 0.78 | 0.77 | 13 |
| | ionosphere | 0.74 | 0.81 | 1,771 | 0.91 | 0.89 | 0.98 | 0.93 | 119 |
| | kidney | 0.99 | 0.99 | 218 | 1.0 | 1.0 | 1.0 | 1.0 | 16 |
| | voting | 0.94 | 0.93 | 43 | 0.95 | 0.92 | 0.96 | 0.94 | 11 |
| | credit-a | 0.84 | 0.84 | 356 | 0.85 | 0.92 | 0.79 | 0.85 | 36 |
| | breast-w | 0.97 | 0.98 | 48 | 0.94 | 0.88 | 0.97 | 0.92 | 9 |
| | autism | 0.96 | 0.97 | 56 | 0.91 | 0.94 | 0.94 | 0.94 | 29 |
| | parkinson | 0.67 | 0.71 | 152,056 | 0.82 | 0.82 | 0.96 | 0.89 | 9,691 |
| | cars | 1.0 | 1.0 | 83 | 0.96 | 1.0 | 0.94 | 0.97 | 20 |
| | kr vs. kp | 1.0 | 0.99 | 273 | 0.97 | 0.96 | 0.97 | 0.97 | 152 |
| | mushroom | 1.0 | 1.0 | 394 | 1.0 | 1.0 | 0.99 | 1.0 | 254 |
| | intention | 0.88 | 0.89 | 41,992 | 0.90 | 0.95 | 0.93 | 0.94 | 661 |
| | eeg | 0.71 | 0.71 | 9,001 | 0.67 | 0.74 | 0.63 | 0.68 | 1,227 |
| | credit card | NA | NA | NA | 0.82 | 0.83 | 0.96 | 0.89 | 3,513 |
| | adult | 0.87 | 0.87 | 300,380 | 0.84 | 0.86 | 0.95 | 0.90 | 1,746 |
| | rain in aus | 0.89 | 0.88 | 243,990 | 0.82 | 0.85 | 0.94 | 0.89 | 10,243 |

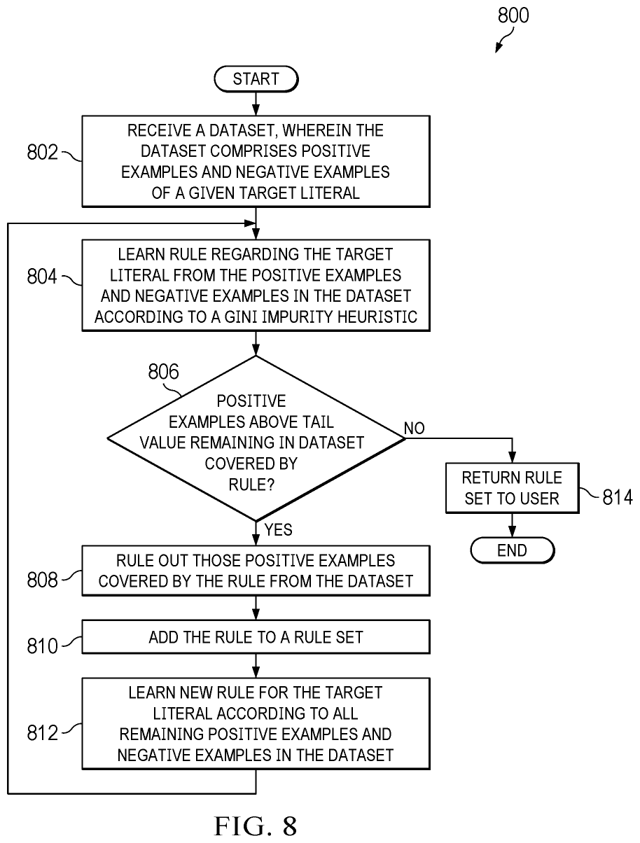

FIG. 8 depicts a flowchart illustrating a process for automated inductive machine learning in accordance with an illustrative embodiment. Process 800 can be implemented in hardware, software, or both. When implemented in software, the process can take the form of program instructions that is run by one of more processor units located in one or more hardware devices in one or more computer systems. Process 800 may be an example implementation of the algorithms in FIGS. 4-7 in inductive learning system 200 shown in FIG. 2.

Process 800 begins by receiving a dataset, wherein the dataset comprises positive examples and negative examples of a given target literal (step 802). The dataset may comprise both numerical and categorical data. The system then learns a rule regarding the target literal from the positive examples and negative examples in the dataset according to a gini impurity heuristic (step 804).

The system then determines if there are a number of the positive examples in the dataset above a specified tail value are covered by the rule (step 806). Responsive to a determination that covered positive examples do number above the tail value the system rules out those positive examples covered by the rule from the dataset (step 808) and adds the rule to a rule set (step 810). Process 800 then returns to step 804 to learn a new rule for the target literal according to all remaining positive examples and negative examples in the dataset (step 812).

Responsive to a determination that there are no remaining positive examples in the dataset covered by the rule, the system returns the rule set to a user (step 814). The rule set comprises default rules with exceptions. The rule set specifies in natural language the rules for machine learning prediction. The rule set may be executable on an s(CASP) ASP system.

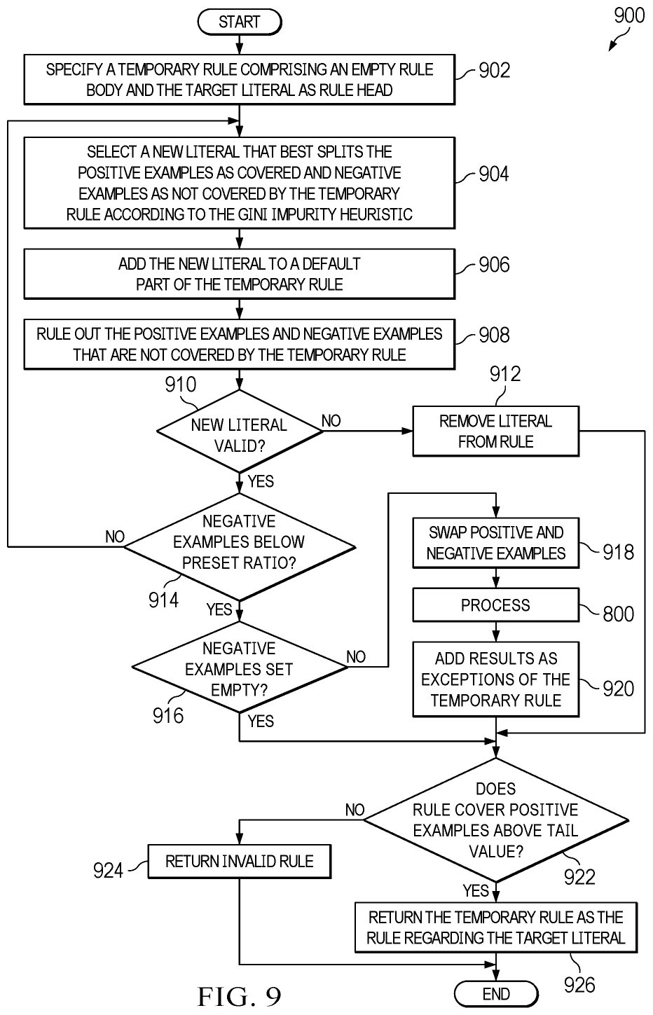

FIG. 9 depicts a flowchart illustrating a process for learning a rule regarding a target literal. Process 900 is a recursive process that may be called by the inductive learning system 200 at step 804 of process 800.

Process 900 begins by specifying a temporary rule comprising an empty rule body and the target literal as rule head (step 902). The system then selects a new literal that best splits the positive examples as covered and negative examples as not covered by the temporary rule according to the gini impurity heuristic (step 904) and adds the new literal to the default part of the temporary rule (step 906).

The system rules out the positive examples and negative examples that are not covered by the temporary rule (step 908). The system determines if the new literal is valid (step 910). If the new literal is invalid the system removes the new literal from the temporary rule (step 912) and proceeds to step 922.

If the new literal is valid, the system determines if the negative examples are below a preset ratio of negative examples to total examples (both positive and negative) (step 914). If the negative examples are not below the preset ratio, the system returns to step 904.

If the negative examples are below the preset ratio, the system determines if the negative examples comprise an empty set (step 918). If negative examples are not an empty set, the system swaps the positive and negative examples (step 918) and calls process 800 using the swapped positive and negative examples to learn an exception rule set. The exception rule set is then added to an exception part of the temporary rule rather than the default part (step 920).

The system then determines if the temporary rule covers a number of the positive examples above the specified tail size (step 922). Responsive to a determination that the temporary rule does not cover a number of the positive example above the specified tail size, the system returns the temporary rule as invalid (step 924).

Responsive to a determination that the temporary rule covers a number of the positive example above the specified tail size, the system returns the temporary rule as the rule regarding the target literal (step 926). Process 900 then ends.

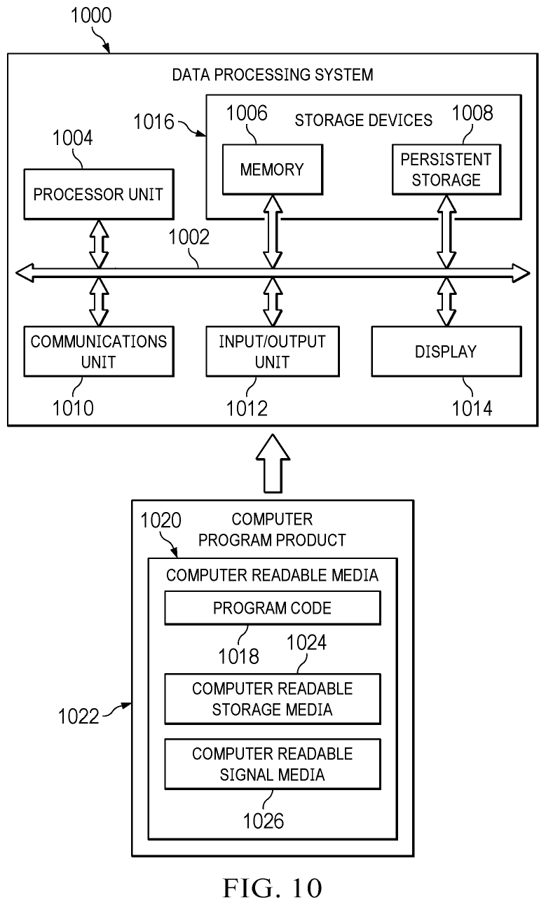

Turning now to FIG. 10, an illustration of a block diagram of a data processing system is depicted in accordance with an illustrative embodiment. Data processing system 1000 may be used to implement server computers 104 and 106 and client devices 110 in FIG. 1, as well as computer system 250 in FIG. 2. In this illustrative example, data processing system 1000 includes communications framework 1002, which provides communications between processor unit 1004, memory 1006, persistent storage 1008, communications unit 1010, input/output (I/O) unit 1012, and display 1014. In this example, communications framework 1002 takes the form of a bus system.

Processor unit 1004 serves to execute instructions for software that may be loaded into memory 1006. Processor unit 1004 may be a number of processors, a multi-processor core, or some other type of processor, depending on the particular implementation. In an embodiment, processor unit 1004 comprises one or more conventional general-purpose central processing units (CPUs). In an alternate embodiment, processor unit 1004 comprises one or more graphical processing units (CPUs).

Memory 1006 and persistent storage 1008 are examples of storage devices 1016. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1016 may also be referred to as computer-readable storage devices in these illustrative examples. Memory 1006, in these examples, may be, for example, a random access memory or any other suitable volatile or non-volatile storage device. Persistent storage 1008 may take various forms, depending on the particular implementation.

For example, persistent storage 1008 may contain one or more components or devices. For example, persistent storage 1008 may be a hard drive, a flash memory, a rewritable optical disk, a rewritable magnetic tape, or some combination of the above. The media used by persistent storage 1008 also may be removable. For example, a removable hard drive may be used for persistent storage 1008. Communications unit 1010, in these illustrative examples, provides for communications with other data processing systems or devices. In these illustrative examples, communications unit 1010 is a network interface card.

Input/output unit 1012 allows for input and output of data with other devices that may be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs may be located in storage devices 1016, which are in communication with processor unit 1004 through communications framework 1002. The processes of the different embodiments may be performed by processor unit 1004 using computer-implemented instructions, which may be located in a memory, such as memory 1006.

These instructions are referred to as program code, computer-usable program code, or computer-readable program code that may be read and executed by a processor in processor unit 1004. The program code in the different embodiments may be embodied on different physical or computer-readable storage media, such as memory 1006 or persistent storage 1008.

Program code 1018 is located in a functional form on computer-readable media 1020 that is selectively removable and may be loaded onto or transferred to data processing system 1000 for execution by processor unit 1004. Program code 1018 and computer-readable media 1020 form computer program product 1022 in these illustrative examples. In one example, computer-readable media 1020 may be computer-readable storage media 1024 or computer-readable signal media 1026.

In these illustrative examples, computer-readable storage media 1024 is a physical or tangible storage device used to store program code 1018 rather than a medium that propagates or transmits program code 1018. Computer readable storage media 1024, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1018 may be transferred to data processing system 1000 using computer-readable signal media 1026. Computer-readable signal media 1026 may be, for example, a propagated data signal containing program code 1018. For example, computer-readable signal media 1026 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1000 are not meant to provide architectural limitations to the manner in which different embodiments may be implemented. The different illustrative embodiments may be implemented in a data processing system including components in addition to or in place of those illustrated for data processing system 1000. Other components shown in FIG. 10 can be varied from the illustrative examples shown. The different embodiments may be implemented using any hardware device or system capable of running program code 1018.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of different types of networks” is one or more different types of networks. In illustrative example, a “set of” as used with reference items means one or more items. For example, a set of metrics is one or more of the metrics.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for automated inductive machine learning, the method comprising:
using a number of processors to perform the steps of:
a) receiving a dataset, wherein the dataset comprises positive examples and negative examples of a given target literal;
b) learning a rule regarding the target literal from the positive examples and negative examples in the dataset according to a gini impurity heuristic;
c) responsive to a determination that there are a number of the positive examples in the dataset above a specified tail value are covered by the rule:
ruling out those positive examples covered by the rule from the dataset;
adding the rule to a rule set; and
returning to step b) to learn a new rule for the target literal according to all remaining positive examples and negative examples in the dataset; and
d) responsive to a determination that there are no remaining positive examples in the dataset covered by the rule, returning the rule set to a user.

2. The method of claim 1, wherein the rule set specifies in natural language the rules for machine learning prediction.

3. The method of claim 1, wherein the rule set comprises default rules with exceptions.

4. The method of claim 1, wherein learning the rule regarding the target literal comprises:
e) specifying a temporary rule comprising an empty rule body and the target literal as rule head;
f) selecting a new literal that best splits the positive examples as covered and negative examples as not covered by the temporary rule according to the gini impurity heuristic;
g) adding the new literal to a default part of the temporary rule;
h) ruling out the positive examples and negative examples that are not covered by the temporary rule;
i) determining whether the temporary rule covers a number of the positive examples above the specified tail size;
j) responsive to a determination that the temporary rule covers a number of the positive examples above the specified tail size, returning the temporary rule as the rule regarding the target literal; and
k) responsive to a determination that the temporary rule does not cover a number of the positive example above the specified tail size, returning the temporary rule as invalid.

5. The method of claim 4, further comprising:
determining whether the new literal is valid; and
responsive to a determination that the new literal is invalid, removing the new literal from the temporary rule.

6. The method of claim 4, further comprising:
determining whether the negative examples number below a preset ratio; and
responsive to a determination that the negative examples do not number below the preset ratio, repeating steps e) through h).

7. The method of claim 4, further comprising:
determining whether a set of the negative examples is empty;
responsive to a determination that the set of negative examples is not empty, swapping the positive and negative examples;
repeating steps a) through d) with the swapped positive and negative examples to learn an exception rule set; and
adding the exception rule set to an exception part of the temporary rule.

8. The method of claim 1, wherein the rule set is executable on an s(CASP) (solver for Constraints Answer Set Programs) system.

9. The method of claim 1, wherein the dataset comprises both numerical and categorical data.

10. A system for automated inductive machine learning, the system comprising:
a storage device configured to store program instructions; and
one or more processors operably connected to the storage device and configured to execute the program instructions to cause the system to:
a) receive a dataset, wherein the dataset comprises positive examples and negative examples of a given target literal;
b) learn a rule regarding the target literal from the positive examples and negative examples in the dataset according to a gini impurity heuristic;
c) responsive to a determination that there are a number of the positive examples in the dataset above a specified tail value are covered by the rule:
rule out those positive examples covered by the rule from the dataset;
add the rule to a rule set; and
return to step b) to learn a new rule for the target literal according to all remaining positive examples and negative examples in the dataset; and
d) responsive to a determination that there are no remaining positive examples in the dataset covered by the rule, return the rule set to a user.

11. The system of claim 10, wherein the rule set specifies in natural language the rules for machine learning prediction.

12. The system of claim 10, wherein the rule set comprises default rules with exceptions.

13. The system of claim 10, wherein to learn the rule regarding the target literal the processors further execute instructions to:
e) specify a temporary rule comprising an empty rule body and the target literal as rule head;
f) select a new literal that best splits the positive examples as covered and negative examples as not covered by the temporary rule according to the gini impurity heuristic;
g) add the new literal to a default part of the temporary rule;
h) rule out the positive examples and negative examples that are not covered by the temporary rule; and
i) determine whether the temporary rule covers a number of the positive examples above the specified tail size;
j) responsive to a determination that the temporary rule covers a number of the positive examples above the specified tail size, return the temporary rule as the rule regarding the target literal; and
k) responsive to a determination that the temporary rule does not cover a number of the positive example above the specified tail size, return the temporary rule as invalid.

14. The system of claim 13, wherein the processors further execute instructions to:
determine whether the new literal is valid; and
responsive to a determination that the new literal is invalid, removing the new literal from the temporary rule.

15. The system of claim 13, wherein the processors further execute instructions to:
determine whether the negative examples number below a preset ratio; and
responsive to a determination that the negative examples do not number below the preset ratio, repeat steps e) through h).

16. The system of claim 13, wherein the processors further execute instructions to:
determine whether a set of the negative examples is empty;
responsive to a determination that the set of negative examples is not empty, swap the positive and negative examples;
repeat steps a) through d) with the swapped positive and negative examples to learn an exception rule set; and
add the exception rule set to an exception part of the temporary rule.

17. The system of claim 10, wherein the rule set is executable on an s(CASP) (solver for Constraints Answer Set Programs) system.

18. The system of claim 10, wherein the dataset comprises both numerical and categorical data.

19. A computer program product for automated inductive machine learning, the computer program product comprising:
a computer-readable storage medium having program instructions embodied thereon to perform the steps of:
a) receiving a dataset, wherein the dataset comprises positive examples and negative examples of a given target literal;
b) learning a rule regarding the target literal from the positive examples and negative examples in the dataset according to a gini impurity heuristic;
c) responsive to a determination that there are a number of the positive examples in the dataset above a specified tail value are covered by the rule:
ruling out those positive examples covered by the rule from the dataset;
adding the rule to a rule set; and
returning to step b) to learn a new rule for the target literal according to all remaining positive examples and negative examples in the dataset; and
d) responsive to a determination that there are no remaining positive examples in the dataset covered by the rule, returning the rule set to a user.

20. The computer program product of claim 19, wherein the rule set specifies in natural language the rules for machine learning prediction.

21. The computer program product of claim 19, wherein the rule set comprises default rules with exceptions.

22. The computer program product of claim 19, wherein learning the rule regarding the target literal comprises instructions for:
e) specifying a temporary rule comprising an empty rule body and the target literal as rule head;
f) selecting a new literal that best splits the positive examples as covered and negative examples as not covered by the temporary rule according to the gini impurity heuristic;
g) adding the new literal to a default part of the temporary rule;
h) ruling out the positive examples and negative examples that are not covered by the temporary rule; and
i) determining whether the temporary rule covers a number of the positive examples above the specified tail size;
j) responsive to a determination that the temporary rule covers a number of the positive examples above the specified tail size, returning the temporary rule as the rule regarding the target literal; and
k) responsive to a determination that the temporary rule does not cover a number of the positive example above the specified tail size, returning the temporary rule as invalid.

23. The computer program product of claim 22, further comprising instructions for:
determining whether the new literal is valid; and
responsive to a determination that the new literal is invalid, removing the new literal from the temporary rule.

24. The computer program product of claim 22, further comprising instructions for:
determining whether the negative examples number below a preset ratio; and
responsive to a determination that the negative examples do not number below the preset ratio, repeating steps e) through h).

25. The computer program product of claim 22, further comprising instructions for:
determining whether a set of the negative examples is empty;
responsive to a determination that the set of negative examples is not empty, swapping the positive and negative examples;
repeating steps a) through d) with the swapped positive and negative examples to learn an exception rule set; and
adding the exception rule set to an exception part of the temporary rule.

26. The computer program product of claim 19, wherein the rule set is executable on an s(CASP) (solver for Constraints Answer Set Programs) system.

27. The computer program product of claim 19, wherein the dataset comprises both numerical and categorical data.
